(19) United States
(12) Patent Application Publication
(10) Pub. No.: US 2013/0084916 A1
(43) Pub. Date: Apr. 4, 2013

(54) PORTABLE TRANSITIONAL IDENTITY DEVICE

(71) Applicant: Eitan Konstantino, Orinda, CA (US)

(72) Inventor: Eitan Konstantino, Orinda, CA (US)

(73) Assignee: CellTwo Inc. PTE. LTD., Singapore (SG)

(21) Appl. No.: 13/434,020

(22) Filed: Mar. 29, 2012

Related U.S. Application Data
(60) Provisional application No. 61/468,989, filed on Mar. 29, 2011.

(51) Int. Cl. H04W 88/06

(52) U.S. Cl. CPC H04W 88/06
USPC 455/552.1

(57) ABSTRACT

A portable transitional identity device can be used with a conventional cell phone or other mobile device using a cellular network to provide access to one or more additional networks, optionally with encryption.

### CROSS-REFERENCES TO RELATED APPLICATIONS

The present application claims the benefit of U.S. Provisional Patent Application Ser. No. 61/468,989, filed Mar. 29, 2011, the full disclosure of which is incorporated herein by reference.

### BACKGROUND OF THE INVENTION

The invention addresses the need to use multiple simultaneous transmissions from any device having a wireless radio chip set with blue tooth or WiFi capabilities. Further the invention enables encrypted communication for non encrypted devices such as IPhone or other conventional phones without changes to the hardware. Using the device disclosed here allows conversion of any phone to a multi number phone with simultaneous usage and encryption capabilities retaining the familiar user interface, address book, applications etc. on the original phone. The portable communication device presents a single, consistent identity regardless of the network being use (for example will show user name in addition to ad hock phone number generated by provisional or temporary SIM card used)

### BRIEF SUMMARY OF THE INVENTION

To address these difficulties, the present invention provides a Portable Transitional Identity Device (PTID), which can be used with most mass market cell phones to improve useability, particularly when away from home. The Portable Transitional Identity Device may be combined with a current radio chipset, and will utilize the device radio capabilities, to be able communicate with more than one cellular provider. For example, a device which runs over the AT&T network can host a Verizon wireless network user. The user can use a phone either to place calls by AT&T or to place calls with VerizonWireless. Using two different devices today means additional phones and chargers. By activating the “Portable Transitional Identity Device,” a user can use a single phone and charger to connect to more than one network.

The “Portable Transitional Identity Device” will increase the phone overall usage because it eliminates the need to use extra devices, with extra chargers, and avoids incurring excessive fees. The user can either dial with the local host number, or with a virtual phone number, leading to great savings, an increase in user availability, a single phonebook, shared application access, with the flexibility of picking a network provider.

A principal advantage this solution is simplicity. It allows the use of the existing devices as hosts, while the “Portable Transitional Identity Device” will utilize the radio resources in parallel to the “host” phone.

The “Portable Transitional Identity Device” is not necessarily limited to a host phone. The “Portable Transitional Identity Device” technology can be adjusted to run on any device with radio chip technology, or wireless connectivity, like laptops and tablets. The PTID can connect to a satellite chip set for worldwide connectivity. The “virtual phone” provided by the PTID does not change the device basic features. It allows any present mobile device with a radio chip to run on any network that the PTID defines.

### BRIEF DESCRIPTION OF THE DRAWINGS

FIG. 1 is an encryption table.

FIG. 2 is a block diagram illustrating the PTID in a mobile device.

FIG. 3 is a more complete block diagram of the PTID in a mobile device.

FIG. 4 illustrates the PTID being used with encryption.

FIG. 5 further illustrates the PTID being used with encryption.

FIG. 6 provides a flow chart showing how the PTID can be used with a conventional mobile device.

FIGS. 7-9 illustrate more detailed implementations of the present invention.

### DETAILED DESCRIPTION OF THE INVENTION

The “Portable Transitional Identity Device” can be used for military applications. For example, a device which lacks encryption can be used on a military network, because the PTID can add an encryption. In this way, encryption can be added to mass market ‘off shelf’ products. Thus, the combination of a mass market device with the “Portable Transitional Identity Device” can be a cost efficient solution for many government agencies which need communication devices that offer high encryption.

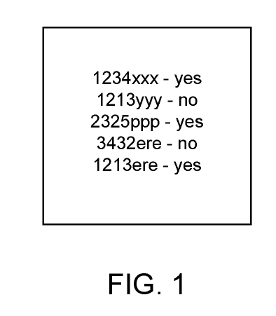

Since encryption today (based on VPN) consumes a great deal of power and drains the battery faster, we will open the encryption from the “Portable Transitional Identity Device” to either or both the originator generic encryption server, our via encryption solution located independently as shown in FIG. 1. The “Portable Transitional Identity Device” will generate a table which will hold the numbers needed to go via encryption.

Such encryption will work as follows: The “Portable Transitional Identity Device” will initiate a pilot packet towards the encryption server—with some basic info (phone #). The server will reject the initial ‘pilot packet’ but will send a key to the “Portable Transitional Identity Device”. The “Portable Transitional Identity Device” will use the key and will send it back to the host device. The host device will authorize a new request with the auth key will be send out to the server, and it will be granted.

Since PTID will provide two radio chipsets (one is the phone it self, the other is within the “Portable Transitional Identity Device”), network selection can be based on pricing. When a user powers up the phone, with the “Portable Transitional Identity Device” attached, there will be an option to pick a less expansive network to work with.

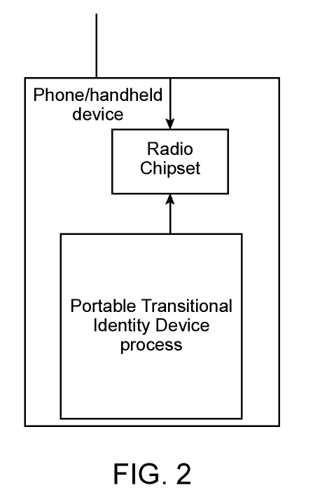

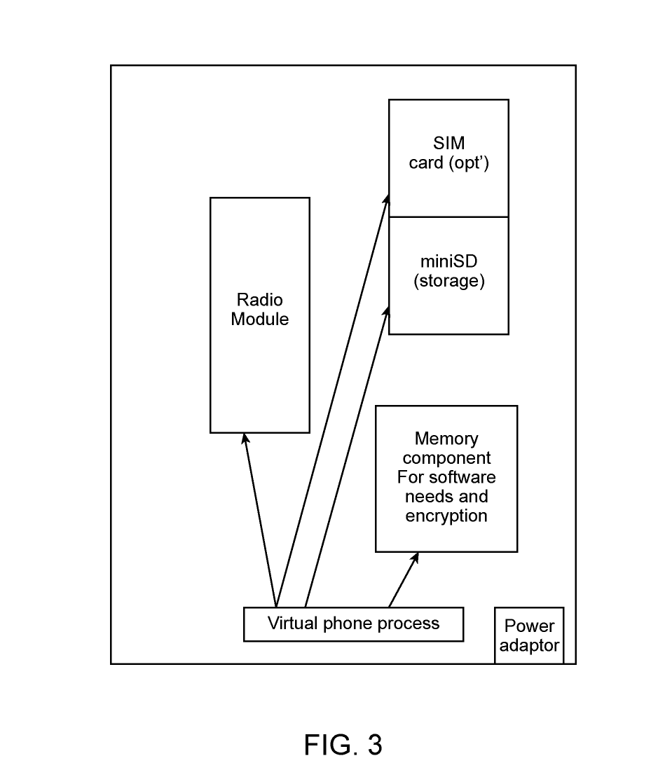

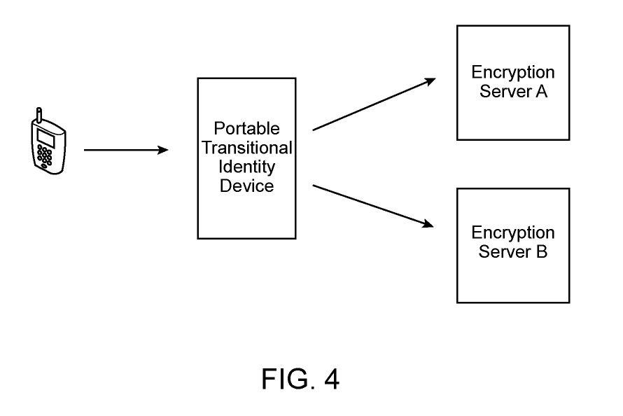

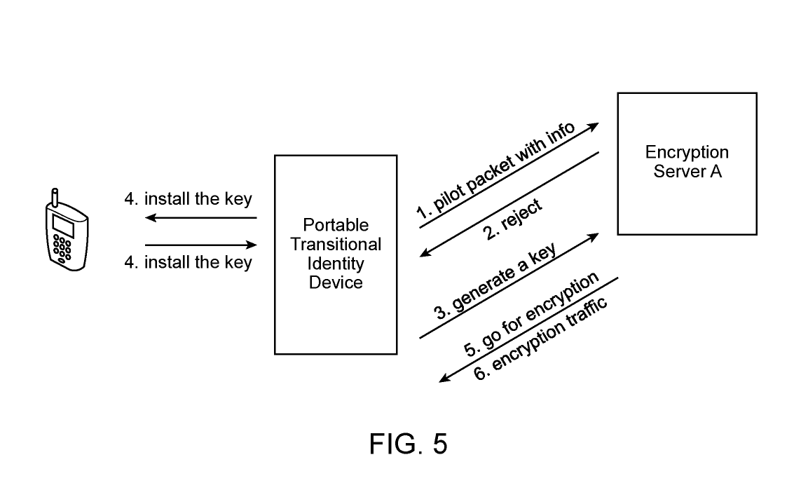

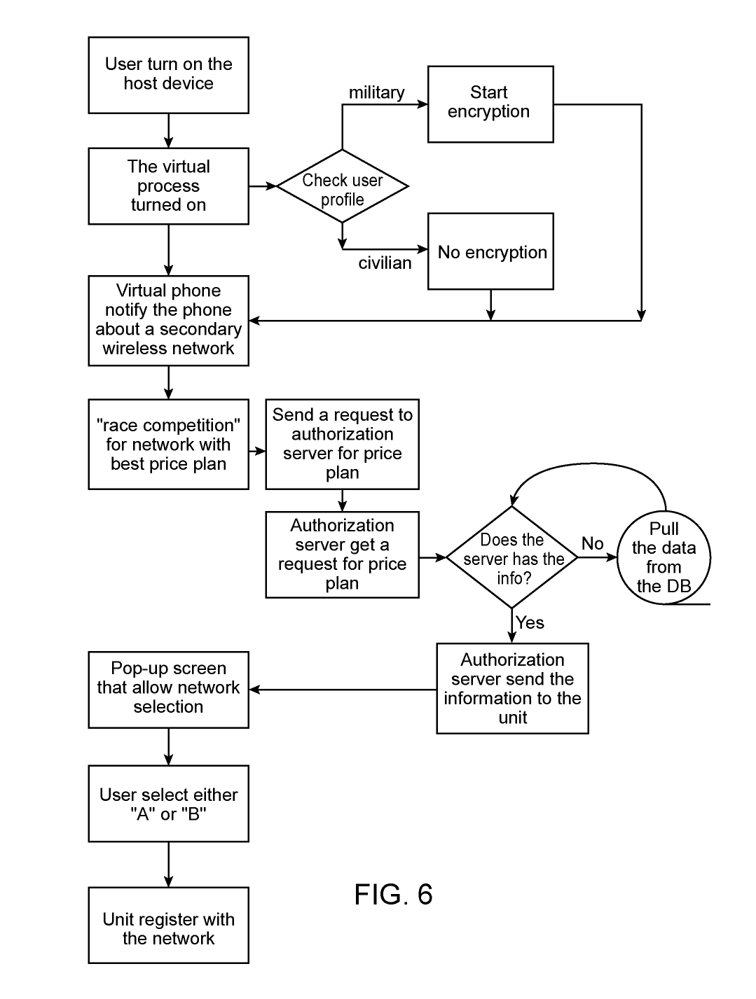

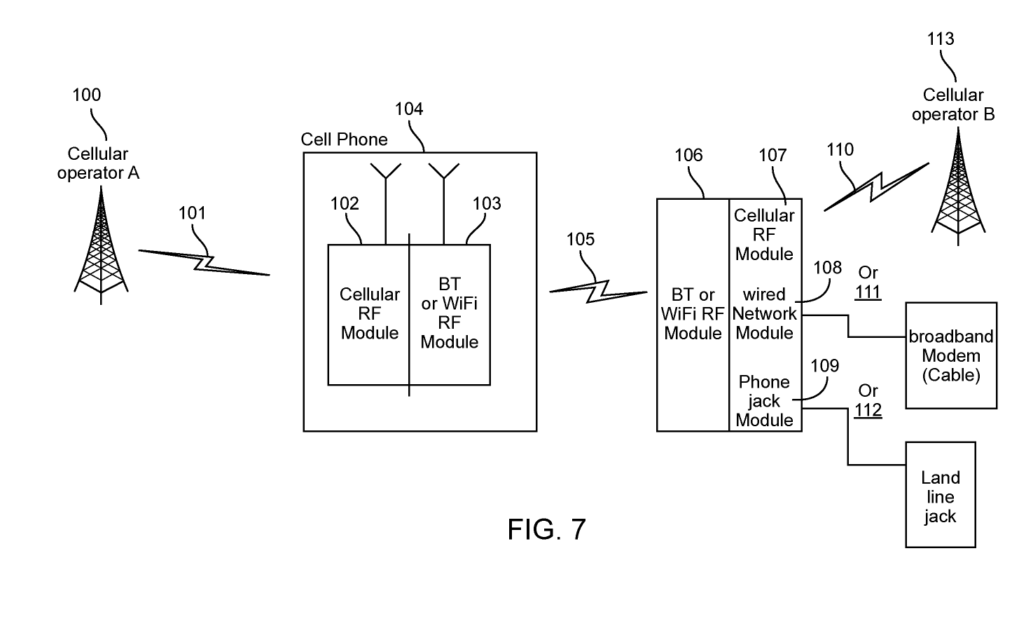

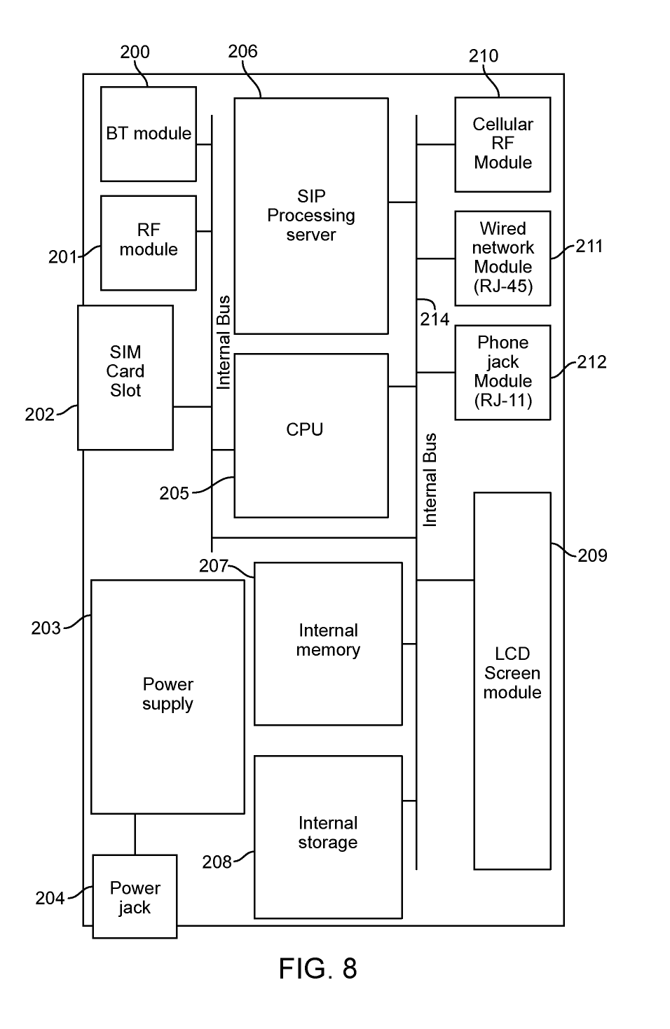

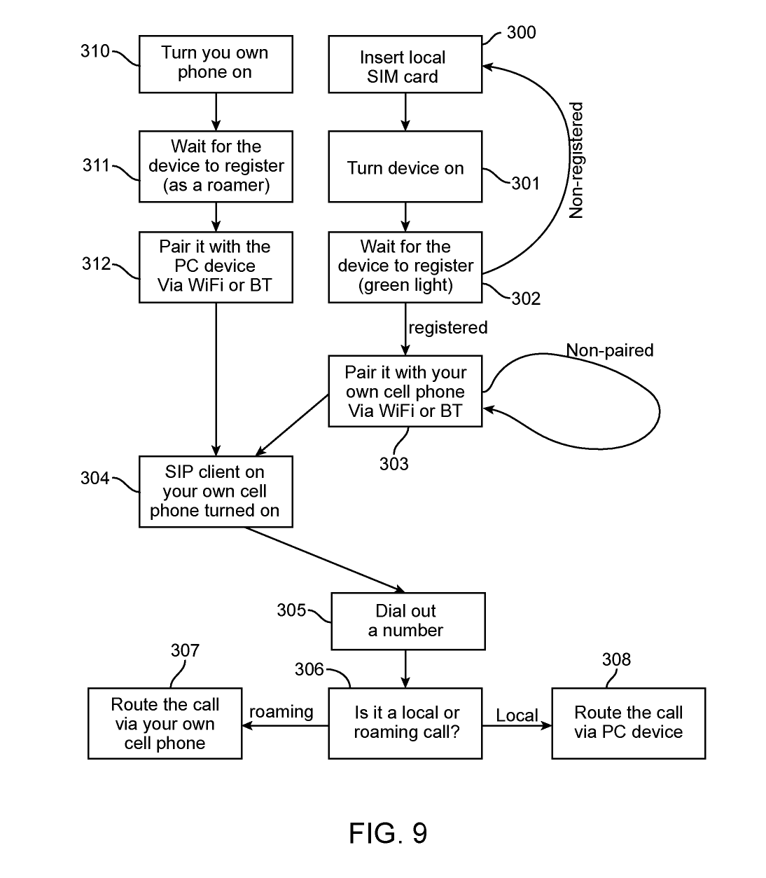

Details of the system are illustrated in FIGS. 2-9.

Thus, while the preferred embodiments of the devices and methods have been described in reference to the environment in which they were developed, they are merely illustrative of the principles of the inventions. Other embodiments and configurations may be devised without departing from the spirit of the inventions and the scope of the appended claims.

What is claimed is:

1. A portable transitional identity device (PTID) that can be coupled to a mobile device having a radio chipset that is configured to connect to a first cellular service provider, wherein said PTID is configured to provide connection to at least a second cellular service provider.

2. A portable transitional identity device (PTID) as in claim 1, wherein said PTID is configured to provide an encrypted connection over the second cellular connection.

3. A portable transitional identity device (PTID) as in claim 1, which is a short range device.

4. A method for communication with a mobile device connectable to a first cellular network, said method comprising a PTID as in claim 1, and connection to a second cellular network using the PTID.

5. A method as in claim 4, wherein the connection between the mobile device and the PTID is wireless.

6. A method as in claim 4, wherein the PTID selects between the first cellular network and the second cellular network based on cost.

7. A method as in claim 4, wherein the PTID selects between the first cellular network for personal use and the second cellular network for business use.
